(19) United States
(12) Patent Application Publication
(10) Pub. No.: US 2024/0352242 A1
(43) Pub. Date: Oct. 24, 2024

(54) FLAME RETARDANT POLYPROPYLENE COMPOSITION COMPRISING A BIOPOLYMER

(71) Applicant: Borealis AG, Vienna (AT)

(72) Inventors: Roberta Pellecchia, Linz (AT); Antonios Gitsas, Linz (AT); Konrad Gebauer, Leipzig (DE); Wolfgang Stockreiter, Linz (AT); Florian Schütz, Vienna (AT); Francis Reny Costa, Linz (AT); Anton Sageder, Linz (AT)

(21) Appl. No.: 18/290,950

(22) PCT Filed: Jul. 28, 2022
(86) PCT No.: PCT/EP2022/071144

§ 371 Date: Jan. 22, 2024

(30) Foreign Application Priority Data
Jul. 29, 2021 (EP) 21188598.3

(51) Int. Cl. C08L 23/14; C08K 5/52; C08L 97/00

(52) U.S. Cl. CPC C08L 23/142; C08K 5/5205; C08L 97/005; C08L 2201/02; C08L 2207/02

(57) ABSTRACT

The present invention is related to a flame retardant polypropylene composition (C) comprising a propylene polymer (PP), a nitrogen-containing flame retardant (FR) and an antidripping-agent (A) being a biopolymer comprising phenolic hydroxyl groups. Further, the present invention is related to the use of a biopolymer comprising phenolic hydroxyl groups as an antidripping-agent as well as an article comprising the flame retardant polypropylene composition (C).

The present invention is related to a flame retardant polypropylene composition (C) comprising a propylene polymer (PP), a nitrogen-containing flame retardant (FR) and an antidripping-agent (A) being a biopolymer comprising phenolic hydroxyl groups. Further, the present invention is related to the use of a biopolymer comprising phenolic hydroxyl groups as an antidripping-agent as well as an article comprising the flame retardant polypropylene composition (C).

In electrical applications certain flame retardant requirements are requested. Most commonly UL94 V0 rating at specimen thickness equal or above 1.6 mm has to be achieved. Furthermore, for environmental friendliness halogen-free systems are preferred. As part of the UL94 rating next to the burning behavior controlled by flame retardant additives there is the dripping behavior to be controlled where for mainly unfilled or low filled polypropylene grades typically polytetrafluoroethylene (PTFE) is used in an overall amount of 0.2 to 0.3 wt.-%. According to regulations, halogen free flame retardant (HFFR) materials combined with PTFE are still considered halogen free, but in practice a small amount of halogen is present in the formulation. In addition a REACH restriction with the aim of restricting production, placing on the market and use of all per- and polyfluoroalkyl compounds (PFAS) in the EU has been proposed. Thus, fluoropolymers are under consideration for a potential restriction. Therefore, it is of interest to replace the PTFE in flame retardant polypropylene formulations with component that provides a similar performance.

Therefore, it is an object of the present invention to provide a flame retardant polypropylene composition which fulfils the above mentioned UL94 V0 rating and is free of fluoropolymers.

Accordingly, the present invention is directed to a flame retardant polypropylene composition (C), comprising
i) a propylene polymer (PP),
ii) a nitrogen-containing flame retardant (FR), and
iii) an antidripping-agent (A) being a biopolymer comprising phenolic hydroxyl groups,
wherein the polypropylene composition (C) fulfills in-equation (I)

$$\frac{w ( A )}{w ( FR )} < 0.15 \qquad ( I )$$

wherein w(A) is the overall amount of the antidripping-agent (A) in [wt-%], based on the overall weight of the polypropylene composition (C), and w(FR) is the overall amount of the nitrogen-containing flame retardant (FR) in [wt.-%], based on the overall amount of the flame retardant polypropylene composition (C).

It was found that a polypropylene composition comprising a nitrogen-containing flame retardant (FR) and an antidripping-agent (A) being a biopolymer comprising phenolic hydroxyl groups in amounts fulfilling in-equation (I) achieves V0 in the UL94 test without the application of fluoropolymers as antidripping-agents. Therefore, the fluoropolymers can be replaced with an environmental friendly and sustainable biopolymer.

According to one embodiment of the present invention, the flame retardant polypropylene composition (C) is free of halogens.

According to another embodiment of the present invention, the antidripping-agent (A) is lignin.

According to a further embodiment of the present invention, the nitrogen-containing flame retardant (FR) comprises a first nitrogen-containing phosphate (FR1) and a second nitrogen-containing phosphate (FR2).

According to still another embodiment of the present invention, the weight ratio between the first nitrogen-containing phosphate (FR1) and the second nitrogen-containing phosphate (FR2) is in the range of 60:40 to 40:60.

It is especially preferred that the first nitrogen-containing phosphate (FR1) is melamine polyphosphate and the second nitrogen-containing phosphate (FR2) is piperazine pyrophosphate.

According to one embodiment of the present invention, the flame retardant polypropylene composition (C) comprises
i) 57.1 to 89.9 wt.-% of the propylene polymer (PP),
ii) 10.0 to 40.0 wt.-% of the nitrogen-containing flame retardant (FR), and
iii) 0.1 to 2.9 wt.-% of the antidripping-agent (A) being a biopolymer comprising phenolic hydroxyl groups,
based on the overall weight of the polypropylene composition (C).

According to a further embodiment of the present invention, the overall amounts of the propylene polymer (PP), the nitrogen-containing flame retardant (FR) and the antidripping-agent (A) together make up at least 90 wt.-% of the flame retardant polypropylene composition (C), more preferably sum up to 100 wt.-%.

According to another embodiment of the present invention, the propylene polymer (PP) is a copolymer of propylene and ethylene and/or a C₄ to C₈ α-olefin having a comonomer content in the range of 2.0 to 25.0 mol-%, preferably in the range of 6.0 to 15.0 mol-%.

It is especially preferred that the propylene polymer (PP) is a heterophasic propylene copolymer (HECO) comprising
i) a matrix (M) being a polymer of propylene, and
ii) an elastomer (E) being a copolymer comprising units derived from propylene and ethylene and/or C₄ to C₈ a-olefin.

According to one embodiment of the present invention, the heterophasic propylene copolymer (HECO) has a xylene cold soluble fraction (XCS) in the range of 7.0 to 25.0 wt.-%, preferably in the range of 11.0 to 22.0 wt.-%, based on the overall weight of the heterophasic propylene copolymer (HECO).

According to another embodiment of the present invention, the xylene soluble fraction (XCS) of the heterophasic propylene copolymer (HECO) has
i) a comonomer content in the range of 25.0 to 65.0 mol-%, preferably in the range of 40.0 to 45.0 mol-%, and/or
ii) an intrinsic viscosity (IV) measured according to ISO 1628/1 (at 135° C. in decalin) below 3.5 dl/g, preferably in the range of 2.4 to 3.4 dl/g.

According to a further embodiment of the present invention, the flame retardant polypropylene composition (C) has a melt flow rate MFR₂ (230° C., 2.16 kg) determined according to ISO 1133 in the range of 6.0 to 40.0 g/10 min.

The present invention is also directed to the use of a biopolymer comprising phenolic hydroxyl groups, preferably lignin, as an antidripping-agent (A) for a composition comprising a propylene polymer (PP) and a nitrogen-containing flame retardant (FR).

Further, the present invention is directed to an article, comprising the flame retardant polypropylene composition (C) as described above.

In the following, the present invention is described in more detail.

### The Flame Retardant Polypropylene Composition (C)

The flame retardant polypropylene composition (C) according to the present invention comprises a propylene polymer (PP), a nitrogen-containing flame retardant (FR) and an antidripping-agent (A) being a biopolymer comprising phenolic hydroxyl groups.

According to a preferred embodiment of the present invention, the flame retardant polypropylene composition (C) is free of fluoropolymers. In particular, it is preferred that the flame retardant polypropylene composition (C) does not contain fluoropolymers in amounts exceeding 0.5 wt.-%, more preferably 0.1 wt.-%, still more preferably 0.01 wt.-%, like 0.001 wt.-%. It is especially preferred that no fluoropolymers have been used in the production of the flame retardant polypropylene composition (C).

As used herein, the term “fluoropolymer” refers to a polymeric compound comprising fluorine atoms. Examples for fluoropolymers are poly(tetrafluoro ethylene) (PTFE), tetrafluoroethylene-hexafluoropropylene-copolymer (FEP) and polychlorotrifluoroethylene (PCTFE).

According to another preferred embodiment of the present invention, the flame retardant polypropylene composition (C) is free of halogen atoms. As used herein, the term “halogen” refers to the elements of group 17 of the periodic table. Accordingly, it is preferred that no compounds containing halogen atoms have been used in the production of the flame retardant polypropylene composition (C).

The flame retardant polypropylene composition (C) comprises the nitrogen-containing flame retardant (FR) and the antidripping-agent (A) in a weight ratio fulfilling in-equation (I), preferably in-equation (Ia), more preferably in-equation (Ib),

$$\frac{w ( A )}{w ( FR )} < 0 \text{.15} \qquad ( I )$$

$$\frac{w ( A )}{w ( FR )} < 0.1 \qquad ( Ia )$$

$$\frac{w ( A )}{w ( FR )} < 0.08 \qquad ( Ib )$$

wherein w(A) is the overall amount of the antidripping-agent (A) in [wt-%], based on the overall weight of the polypropylene composition (C), and w(FR) is the overall amount of the nitrogen-containing flame retardant (FR) in [wt.-%], based on the overall amount of the flame retardant polypropylene composition (C).

In particular, the flame retardant polypropylene composition preferably comprises
i) 57.1 to 89.9 wt.-%, more preferably 65.0 to 86.0 wt.-%, still more preferably 70.0 to 84.0 wt.-%, like 75.0 to 81.0 wt.-% of the propylene polymer (PP),
ii) 10.0 to 40.0 wt.-%, more preferably 12.0 to 35.0 wt.-%, still more preferably 15.0 to 30.0 wt.-%, like 18.0 to 27.0 wt.-% of the nitrogen-containing flame retardant (FR), and
iii) 0.1 to 2.9 wt.-%, more preferably 0.3 to 2.0 wt.-%, still more preferably 0.5 to 1.8 wt.-%, like 0.8 to 1.5 wt.-% of the antidripping-agent (A) being a biopolymer comprising phenolic hydroxyl groups,
based on the overall weight of the flame retardant polypropylene composition (C).

It is preferred that the overall amounts of the propylene polymer (PP), the nitrogen-containing flame retardant (FR) and the antidripping-agent (A) together make up at least 90 wt.-% of the flame retardant polypropylene composition (C), more preferably sum up to 100 wt.-%.

The flame retardant polypropylene composition (C) according to the present invention may further comprise additives (AD) such as acid scavengers, antioxidants, colorants, light stabilizers, slip agents, anti-scratch agents, dispersing agents, processing aids, lubricants, pigments, and the like.

Accordingly, it is preferred that the flame retardant polypropylene composition (C) comprises, more preferably consists of
i) 52.1 to 89.99 wt.-%, more preferably 65.0 to 86.0 wt.-%, still more preferably 70.0 to 84.0 wt.-%, like 75.0 to 81.0 wt.-% of the propylene polymer (PP),
ii) 10.0 to 40.0 wt.-%, more preferably 12.0 to 35.0 wt.-%, still more preferably 15.0 to 30.0 wt.-%, like 18.0 to 27.0 wt.-% of the nitrogen-containing flame retardant (FR),
iii) 0.1 to 2.9 wt.-%, more preferably 0.3 to 2.0 wt.-%, still more preferably 0.5 to 1.8 wt.-%, like 0.8 to 1.5 wt.-% of the antidripping-agent (A) being a biopolymer comprising phenolic hydroxyl groups, and
iv) 0.01 to 5.0 wt.-%, more preferably 0.1 to 3.5 wt.-%, still more preferably 0.2 to 2.0 wt.-%, like 0.3 to 1.0 wt.-% of additives (AD),
based on the overall weight of the flame retardant polypropylene composition (C). The additives (AD) are described in more detail below.

For embodiments wherein the flame retardant polypropylene composition (C) comprises additives (AD), it is preferred that the overall amounts of the propylene polymer (PP), the nitrogen-containing flame retardant (FR), the antidripping-agent (A) and the additives (AD) together make up at least 90 wt.-% of the flame retardant polypropylene composition (C), more preferably sum up to 100 wt.-%.

It is preferred that the flame retardant polypropylene composition (C) according to the present invention has a melt flow rate MFR₂ (230° C., 2.16 kg) determined according to ISO 1133 in the range of 6.0 to 40.0 g/10 min, more preferably in the range of 10.0 to 35.0 g/10 min, still more preferably in the range of 12.0 to 30.0 g/10 min, like in the range of 13.0 to 25.0 g/10 min.

Regarding the mechanical properties, it is preferred that the polypropylene composition (C) has a tensile modulus determined according to ISO 527-1A at 23° C. in the range of 1000 to 5000 MPa, more preferably in the range of 1100 to 3000 MPa, still more preferably in the range of 1500 to 2500 MPa, like in the range of 1700 to 1900 MPa.

Additionally or alternatively to the previous paragraph, it is preferred that the flame retardant polypropylene composition (C) has a Charpy notched impact strength determined according to ISO 179 1eA at 23° C. of at least 40.0 kJ/m², more preferably in the range of 40.0 to 80.0 kJ/m², still more preferably in the range of 45.0 to 75.0 kJ/m², like in the range of 50 to 70 kJ/m².

Further, it is preferred that the flame retardant polypropylene composition (C) according to the present invention fulfills the requirements of the Standard for Safety of Flammability of Plastic Materials UL 94 V-0 at a thickness of equal or less than 1.6 mm, more preferably equal or less than 1.2 mm, still more preferably equal or less than 1.0 mm, like equal or less than 0.9 mm.

It is preferred that the flame retardant polypropylene composition (C) has an oxidation induction time (OIT), as determined according to ISO 11357-6 at a temperature of 190° C., in the range from 50 to 300 min, more preferably in the range from 60 to 200 min, most preferably in the range from 70 to 100 min.

It is also preferred that the flame retardant polypropylene composition (C) has a limited oxygen index (LOI), as determined according to ASTM D 2863-87, in the range from 25 to 40%, more preferably in the range from 30 to 37%, most preferably in the range from 31 to 35%.

It is furthermore preferred that the flame retardant polypropylene composition (C) has a cone time to ignition, as determined according to ISO5660-1:2019, in the range from 10 to 30 s, more preferably in the range from 15 to 28 s, most preferably in the range from 20 to 26 s.

Preferrably, the flame retardant polypropylene composition (C) has a dripping test value in the range from 0 to 5.0%, more preferably in the range from 0 to 3.0%, most preferably in the range from 0 to 1.0%.

The flame retardant polypropylene composition (C) is preferably obtained by blending, preferably melt-blending the propylene polymer (PP), the nitrogen-containing flame retardant (FR), the antidripping-agent (A) and optionally the additives (AD).

In the following, the propylene polymer (PP), the nitrogen-containing flame retardant (FR), the antidripping-agent (A) are described in more detail.

### The Propylene Polymer (PP)

The flame retardant polypropylene composition (C) according to the present invention comprises a propylene polymer (PP). The propylene polymer (PP) can also be a mixture of two or more propylene polymer (PP) components.

The propylene polymer (PP) has a melt flow rate MFR₂ (230° C., 2.16 kg) determined according to ISO 1133 in the range of 5.0 to 300 g/10 min, more preferably in the range of 8.0 to 100 g/10 min, still more preferably in the range of like in the range of 10.0 to 75.0 g/10 min, like in the range of 15.0 to 50.0 g/10 min.

The propylene polymer (PP) can be a homopolymer or copolymer of propylene. Moreover, the propylene polymer (PP) can comprise one or more propylene polymer (PP) components which are different.

In case the propylene polymer (PP) is a copolymer of propylene, it is preferred that the comonomer is selected from ethylene and/or C₄ to C₈ α-olefins. It is especially preferred that the comonomer is ethylene. For propylene polymers (PP) comprising more than one, like two different propylene polymer components which are copolymers of propylene, it is preferred that all propylene polymer components contain the same comonomer, like ethylene.

It is preferred that the propylene polymer (PP) is a copolymer of propylene and ethylene and/or at least another C₄ to C₈ α-olefin.

The propylene polymer (PP) preferably has a comonomer content, like ethylene content, in the range of 2.0 to 25.0 mol-%, more preferably in the range of 4.0 to 20.0 mol-%, still more preferably in the range of 6.0 to 15.0 mol-%, like in the range of 6.2 to 12.0 mol-%.

In a preferred embodiment of this invention, propylene polymer (PP) is a heterophasic propylene copolymer (HECO) comprising
i) a matrix (M) being a polymer of propylene
ii) an elastomer (E) being a copolymer comprising units derived from propylene and ethylene and/or C₄ to C₈ α-olefin.

Generally in the present invention, the expression “heterophasic” indicates that the elastomer is (finely) dispersed in the matrix. In other words the elastomer forms inclusion in the matrix. Thus the matrix contains (finely) dispersed inclusions being not part of the matrix and said inclusions contain the elastomer. The term “inclusion” according to this invention shall preferably indicate that the matrix and the inclusion form different phases within the heterophasic polypropylene, said inclusions are for instance visible by high resolution microscopy, like electron microscopy or scanning force microscopy.

It is appreciated that the propylene polymer (PP) being a heterophasic propylene copolymer (HECO) preferably has a rather low total comonomer content, preferably ethylene content. Thus, it is preferred that the comonomer content of the heterophasic propylene copolymer (HECO) is in the range from 4.0 to 17.0 mol-%, preferably in the range from 5.0 to 14.0 mol-%, more preferably in the range from 6.0 to 10.0 mol-%.

Heterophasic propylene copolymers (HECO) are generally featured by a xylene cold soluble (XCS) fraction and a xylene cold insoluble (XCI) fraction. For the purpose of the present application the xylene cold soluble (XCS) fraction of the heterophasic propylene copolymers (HECO) is essentially identical with the elastomer of said heterophasic propylene copolymers (HECO).

Accordingly when talking about the intrinsic viscosity and the ethylene content of elastomer of the heterophasic propylene copolymers (HECO) the intrinsic viscosity and the ethylene content of the xylene cold soluble (XCS) fraction of said heterophasic propylene copolymers (HECO) is meant.

Accordingly, the matrix (M) content, i.e. the xylene cold insoluble (XCI) content, in the propylene polymer (PP) being a heterophasic propylene copolymer (HECO) is preferably in the range of 75.0 to 93.0 wt.-%, more preferably in the range of 77.0 to 91.0 wt.-%, like 78.0 to 89.0 wt.-%.

On the other hand the elastomer (E), i.e. the xylene cold soluble (XCS) content, in the propylene polymer (PP) being a heterophasic propylene copolymer (HECO) is preferably in the range of 7.0 to 25.0 wt.-%, more preferably in the range of 9.0 to 23.0 wt.-%, like in the range of 11.0 to 22.0 wt.-%.

The first component of the propylene polymer (PP) as a heterophasic propylene copolymer (HECO) is the matrix (M).

Polypropylenes suitable for use as matrix (M) may include any type of isotactic or predominantly isotactic polypropylene homopolymer or random copolymer known in the art.

Thus the polypropylene may be a propylene homopolymer or an isotactic random copolymer of propylene with ethylene and/or C4 to C8 alpha-olefins, such as for example 1-butene, 1-hexene or 1-octene, wherein the total comonomer content ranges from 0.05 to 10 wt.-%.

Further and preferably the polypropylene matrix (M) has a moderate melt flow rate. Accordingly, it is preferred that in the present invention the polypropylene matrix (M), i.e. the xylene cold insoluble (XCI) fraction of the propylene polymer (PP), has a melt flow rate MFR₂ (230° C., 2.16 kg) determined according to ISO1133 of in a range of 15.0 to 120 g/10 min, more preferably of 20.0 to 100 g/10 min, still more preferably of 30.0 to 80.0 g/10 min, like in the range of 35.0 to 50.0 g/10 min.

Furthermore, the polypropylene matrix (M) can be multimodal or bimodal in view of the molecular weight.

The expression “multimodal” or “bimodal” used throughout the present invention refers to the modality of the polymer, i.e.
the form of its molecular weight distribution curve, which is the graph of the molecular weight fraction as a function of its molecular weight, and/or
the form of its comonomer content distribution curve, which is the graph of the comonomer content as a function of the molecular weight of the polymer fractions.

However, it is preferred that the polypropylene matrix (M) is not multimodal or bimodal.

The second component of the propylene polymer (PP) as a heterophasic propylene copolymer (HECO) is the elastomer (E).

The elastomer (E) comprises, preferably consists of, units derivable from (i) propylene and (ii) ethylene and/or at least another C4 to C8 α-olefin, more preferably units derivable from (i) propylene and (ii) ethylene and at least another α-olefin selected form the group consisting of 1-butene, 1-pentene, 1-hexene, 1-heptene and 1-octene. The elastomeric copolymer (E) may additionally contain units derived from a conjugated diene, like butadiene, or a non-conjugated diene, however it is preferred that the elastomeric copolymer consists of units derivable from (i) propylene and (ii) ethylene and/or C4 to C8 α-olefins only. Suitable non-conjugated dienes, if used, include straight-chain and branched-chain acyclic dienes, such as 1,4-hexadiene, 1,5-hexadiene, 1,6-octadiene, 5-methyl-1, 4-hexadiene, 3,7-dimethyl-1,6-octadiene, 3,7-dimethyl-1,7-octadiene, and the mixed isomers of dihydromyrcene and dihydro-ocimene, and single ring alicyclic dienes such as 1,4-cyclohexadiene, 1,5-cyclooctadiene, 1,5-cyclododecadiene, 4-vinyl cyclohexene, 1-allyl-4-isopropylidene cyclohexane, 3-allyl cyclopentene, 4-cyclohexene and 1-isopropenyl-4-(4-butenyl) cyclohexane. Multi-ring alicyclic fused and bridged ring dienes are also suitable including tetrahydroindene, methyltetrahydroindene, dicyclopentadiene, bicyclo (2,2,1) hepta-2,5-diene, 2-methyl bicycloheptadiene, and alkenyl, alkylidene, cycloalkenyl and cycloalkylidene norbomenes, such as 5-methylene-2-norbomene, 5-isopropylidene norbomene, 5-(4-cyclopentenyl)-2-norbomene; and 5-cyclohexylidene-2-norbornene. Preferred non-conjugated dienes are 5-ethylidene-2-norbomene, 1,4-hexadiene and dicyclopentadiene.

Accordingly the elastomer (E) comprises at least units derivable from propylene and ethylene and may comprise other units derivable from a further α-olefin as defined in the previous paragraph. However it is in particular preferred that elastomer (E) comprises units only derivable from propylene and ethylene and optionally a conjugated diene, like butadiene, or a non-conjugated diene as defined in the previous paragraph, like 1,4-hexadiene. Thus an ethylene propylene non-conjugated diene monomer polymer (EPDM) and/or an ethylene propylene rubber (EPR) as elastomer (E) is especially preferred, the latter most preferred.

Like the matrix (M), the elastomer (E) can be unimodal or multimodal, like bimodal. Concerning the definition of unimodal and multimodal, like bimodal, it is referred to the definition above.

In the present invention the content of units derivable from propylene in the elastomer (E) equates with the content of propylene detectable in the xylene cold soluble (XCS) fraction. Accordingly, the propylene detectable in the xylene cold soluble (XCS) fraction ranges from 20.0 to 80.0 mol-%, more preferably 35.0 to 70.0 mol-%. The comonomers present in the xylene cold soluble (XCS) fraction are those defined above for the elastomer (E). Thus in a specific embodiment the elastomer (E), i.e. the xylene cold soluble (XCS) fraction, comprises from 25.0 to 65.0 mol-%, more preferably 30.0 to 60.0 mol-%, still more preferably 35.0 to 50.0 mol-%, like 40.0 to 45.0 mol-%, units derivable from at least one of the comonomers defined above for the elastomer (E). Preferably, the elastomer (E) is an ethylene propylene non-conjugated diene monomer polymer (EPDM) or an ethylene propylene rubber (EPR), the latter especially preferred, with a propylene and/or ethylene content as defined in this paragraph. In one preferred embodiment, the comonomer of the elastomer (E) is ethylene only.

A further preferred requirement of the present invention is that the intrinsic viscosity (IV) of the xylene cold soluble (XCS) fraction of the propylene polymer (PP) being a heterophasic propylene copolymer (HECO) is rather low. Accordingly it is appreciated that the intrinsic viscosity of the xylene cold soluble (XCS) fraction of the propylene polymer (PP) being a heterophasic propylene copolymer (HECO) is below 3.5 dl/g, more preferably not more than 3.4 dl/g. Even more preferred, the intrinsic viscosity of the xylene cold soluble (XCS) fraction of the propylene polymer (PP) being a heterophasic propylene copolymer (HECO) is in the range of 1.8 to below 3.5 dl/g, more preferably in the range 1.9 to 3.4 dl/g, like 2.0 to 3.4 dl/g. The intrinsic viscosity is measured according to ISO 1628 in decalin at 135° C.

Preferably, the propylene content of the propylene polymer (PP) is 85.0 to 96.0 wt.-%, more preferably 88.0 to 94.0 wt.-%, based on total weight of propylene polymer (PP), more preferably based the amount of the matrix (M) and the elastomeric copolymer (E) together, in case that the propylene polymer (PP) is a heterophasic propylene copolymer (HECO) as defined above.

The propylene polymer (PP) being a heterophasic propylene copolymer (HECO) can be produced by blending the matrix (M) and the elastomer (E). However, it is preferred that the heterophasic propylene copolymer (HECO) is produced in a sequential step process, using reactors in serial configuration and operating at different reaction conditions. As a consequence, each fraction prepared in a specific reactor may have its own molecular weight distribution and/or comonomer content distribution.

The propylene polymer (PP) being a heterophasic propylene copolymer (HECO) according to this invention is preferably produced in a sequential polymerization process, i.e. in a multistage process, known in the art, wherein the (semi)crystalline propylene polymer (M) is produced at least in one slurry reactor, preferably in a slurry reactor and optionally in a subsequent gas phase reactor, and subsequently the elastomer (E) is produced at least in one, i.e. one or two, gas phase reactor(s).

Accordingly it is preferred that the propylene polymer (PP) being a heterophasic propylene copolymer (HECO) is produced in a sequential polymerization process comprising the steps of
(a) polymerizing propylene and optionally at least one ethylene and/or C₄ to C₈ α-olefin in a first reactor (R1) obtaining the first polypropylene fraction of the matrix (M), preferably said first polypropylene fraction is a propylene homopolymer,
(b) optionally transferring the first polypropylene fraction into a second reactor (R2),
(c) optionally polymerizing in the second reactor (R2) and in the presence of said first polypropylene fraction propylene and optionally at least one ethylene and/or C₄ to C₈ α-olefin obtaining thereby a second polypropylene fraction, preferably said second polypropylene fraction is a second propylene homopolymer, said first polypropylene fraction and optionally said second polypropylene fraction form the matrix (M), i.e. the matrix of the heterophasic propylene copolymer (HECO),
(d) transferring the matrix (M) of step (c) into a third reactor (R3),
(e) polymerizing in the third reactor (R3) and in the presence of the matrix (M) obtained in step (a) or (c) propylene and ethylene to obtain the elastomer (E) dispersed in the matrix (M), the matrix (M) and the elastomer (E) form the propylene polymer (PP) being a heterophasic propylene copolymer (HECO).

It is preferred that the propylene polymer (PP) being a heterophasic propylene copolymer (HECO) is prepared in the presence of
(a) a Ziegler-Natta catalyst comprising compounds (TC) of a transition metal of Group 4 to 6 of IUPAC, a Group 2 metal compound (MC) and an internal donor (ID);
(b) optionally a co-catalyst (Co), and
(c) optionally an external donor (ED).

This Ziegler-Natta catalyst can be any stereospecific Ziegler-Natta catalyst for propylene polymerization, which preferably is capable of catalyzing the polymerization and copolymerization of propylene and optional comonomers at a pressure of 500 to 10000 kPa, in particular 2500 to 8000 kPa, and at a temperature of 40 to 110° C., in particular of 60 to 110° C.

Preferably, the Ziegler-Natta catalyst comprises a high-yield Ziegler-Natta type catalyst including an internal donor component, which can be used at high polymerization temperatures of 80° C. or more. Such high-yield Ziegler-Natta catalyst can comprise a succinate, a diether, a citraconate, a phthalate etc., or mixtures therefrom as internal donor (ID). It is preferred that the internal donor is free of phthalate compounds.

According to one preferred embodiment of the present invention, the propylene polymer (PP) consists of the heterophasic propylene copolymer (HECO).

In another embodiment, the propylene polymer (PP) comprises the heterophasic propylene copolymer (HECO) and one or more further homo- or copolymers of propylene such as further heterophasic propylene copolymers. In case the propylene polymer (PP) comprises further copolymers of propylene such as further heterophasic propylene copolymers, it is preferred that the heterophasic propylene copolymer (HECO) and the further copolymers of propylene contain the same comonomer, preferably ethylene.

### The Flame Retardant Composition (FR)

The polypropylene composition (C) according to the present invention comprises a nitrogen-containing flame retardant (FR).

According to a preferred embodiment of the present invention, the nitrogen-containing flame retardant (FR) is free of halogens. In other words, it is preferred that the nitrogen-containing flame retardant (FR) does not contain any organic or inorganic compounds containing halogen atoms. As used herein, the term “halogen” refers to the elements of group 17 of the periodic table.

It is preferred that the nitrogen-containing flame retardant (FR) comprises at least one nitrogen-containing phosphate, preferably at least one organic nitrogen-containing phosphate. Preferably, said organic nitrogen-containing phosphate is a phosphate of heterocyclic C₃-C₆—, more preferably C₃-C₄-alkyl or -aryl compounds comprising at least one N-atom.

According to a preferred embodiment of the present invention, the nitrogen-containing flame retardant (FR) comprises a first nitrogen-containing phosphate (FR1) and a second nitrogen-containing phosphate (FR2) different from the first nitrogen-containing phosphate (FR1).

Preferably, the first nitrogen-containing phosphate (FR1) and the second nitrogen-containing phosphate (FR2) are organic nitrogen-containing phosphates. It is especially preferred that the first nitrogen-containing phosphate (FR1) and the second nitrogen-containing phosphate (FR2) are phosphates of heterocyclic C₃-C₆—, more preferably C₃-C₄-alkyl or -aryl compounds comprising at least one N-atom.

It is preferred that the first nitrogen-containing phosphate (FR1) is an organic nitrogen-containing polyphosphate. More preferably, the first nitrogen-containing phosphate (FR1) is a polyphosphate of a heterocyclic C₃-C₆—, more preferably C₃-C₄-aryl compound comprising at least one N-atom. It is especially preferred that the first nitrogen-containing phosphate (FR1) is melamine polyphosphate.

It is preferred that the second nitrogen-containing phosphate (FR2) is an organic nitrogen-containing diphosphate. More preferably, the second nitrogen-containing phosphate (FR2) is a diphosphate of a heterocyclic C₃-C₆—, more preferably C₃-C₄-alkyl compound comprising at least one N-atom, like two N-atoms. It is especially preferred that the second nitrogen-containing phosphate (FR2) is piperazine pyrophosphate.

According to a preferred embodiment of the present invention, the weight ratio between the first nitrogen-containing phosphate (FR1) and the second nitrogen-containing phosphate (FR2) is in the range of 60:40 to 40:60.

Suitable nitrogen-containing flame retardants (FR) are preferably commercially available. A highly suitable example of a commercial nitrogen-containing flame retardant (FR) is the flame retardant product sold under the trade name Phlamoon-1090A, produced and supplied by SULI.

As outlined above, the polypropylene composition (C) according to the present invention comprises 10.0 to 40.0 wt.-%, more preferably 12.0 to 35.0 wt.-%, still more preferably 15.0 to 30.0 wt.-%, like 18.0 to 27.0 wt.-% of the nitrogen-containing flame retardant (FR), based on the overall weight of the polypropylene composition (C).

The amount of the nitrogen-containing flame retardant (FR) means herein the amount based on the overall weight of the polypropylene composition (C) of the nitrogen-containing flame retardant (FR) as supplied by the producer thereof. Accordingly, the nitrogen-containing flame retardant (FR) may contain further components in minor amounts, like additives, flame retardant synergists and/or carrier medium. Thus it is to be understood that such further components are calculated to the amount of the nitrogen-containing flame retardant (FR).

### The Antidripping-Agent (A)

The inventive polypropylene composition (C) further comprises an antidripping-agent (A).

As used herein, the term “antidripping-agent” refers to an additive that prevents or reduces the effect of dripping of a polymeric material under UL94 test conditions. During the UL94 test, it needs to be observed whether or not the specimen drips and, if any, whether the drops are flaming. The rating of a polymeric product in the UL94 vertical burning test depends on the burning time and the dripping phenomena. The burning time after removal of the ignition source determines whether the polymer is V0, V1, V2, or no grade (fail). The dripping phenomena discriminate between the V2 grade and the V1 grade. If the flaming material drips and ignites the cotton placed under the test specimen, the grade of the polymeric product will be rated as V2. Clearly, the dripping phenomena are important to the UL94 vertical test (see Y. Wang et al., Journal of Fire Sciences 2012, 30(6), 477-501).

According to a preferred embodiment of the present invention, the antidripping-agent (A) is free of halogens. In other words, it is preferred that the antidripping-agent (A) does not contain any organic or inorganic compounds containing halogen atoms. As used herein, the term “halogen” refers to the elements of group 17 of the periodic table.

It is preferred that the flame retardant polypropylene composition (C) comprises 0.1 to 2.9 wt.-%, more preferably 0.3 to 2.0 wt.-%, still more preferably 0.5 to 1.8 wt.-%, like 0.8 to 1.5 wt.-% of the antidripping-agent (A), based on the overall weight of the polypropylene composition (C).

The antidripping-agent (A) according to the present invention is a biopolymer comprising phenolic hydroxyl groups. As used herein, the term “biopolymer” refers to a polymer produced in the cells of a living organism.

It is especially preferred that said biopolymer is crosslinked.

In particular, it is preferred that the antidripping-agent (A) is lignin.

### The Additives (AD)

In addition to the propylene copolymer (PP), the nitrogen-containing flame retardant (FR), and the antidripping-agent (A), the flame retardant polypropylene composition (C) of the invention may include additives (AD). Typical additives are acid scavengers, antioxidants, colorants, light stabilizers, slip agents, anti-scratch agents, dispersing agents, processing aids, lubricants, pigments, and the like.

The content of additives in the flame retardant polypropylene composition (C) of the invention will normally not exceed 5.0 wt.-%, preferably is in the range of 0.01 to 5.0 wt.-%, more preferably 0.1 to 3.5 wt.-%, still more preferably 0.2 to 2.0 wt.-%, like 0.3 to 1.0 wt.-0.

Such additives are commercially available and for example described in “Plastic Additives Handbook”, 6th edition 2009 of Hans Zweifel (pages 1141 to 1190).

Furthermore, the term “additives (AD)” according to the present invention also includes carrier materials, in particular polymeric carrier materials.

### The Polymeric Carrier Material

Preferably the flame retardant polypropylene composition (C) of the invention does not comprise (a) further polymer (s) different to the propylene polymer (PP) in an amount exceeding 5.0 wt.-%, preferably in an amount exceeding 3.0 wt.-%, more preferably in an amount exceeding 2.0 wt.-%, based on the weight of the flame retardant polypropylene composition (C). Any polymer being a carrier material for additives (AD) is not calculated to the amount of polymeric compounds as indicated in the present invention, but to the amount of the respective additive.

The polymeric carrier material of the additives (AD) is a carrier polymer to ensure a uniform distribution in the flame retardant polypropylene composition (C) of the invention. The polymeric carrier material is not limited to a particular polymer. The polymeric carrier material may be ethylene homopolymer, ethylene copolymer obtained from ethylene and α-olefin comonomer such as C3 to C8 α-olefin comonomer, propylene homopolymer and/or propylene copolymer obtained from propylene and α-olefin comonomer such as ethylene and/or C4 to C8 α-olefin comonomer. It is preferred that the polymeric carrier material does not contain monomeric units derivable from styrene or derivatives thereof.

### The Use

The present invention is further directed to the use of a biopolymer comprising phenolic hydroxyl groups, preferably lignin, as an antidripping agent (A) for a composition comprising a propylene polymer (PP) and a nitrogen-containing flame retardant (FR).

Regarding the propylene polymer (PP) and the nitrogen-containing flame retardant (FR), reference is made to the definitions provided above.

### The Article

The present invention also relates to an article comprising the flame retardant polypropylene composition (C) as defined above. The present invention in particular relates to an article comprising at least 60 wt.-%, more preferably at least 80 wt.-%, still more preferably at least 90 wt.-%, like at least 95 wt.-% or at least 99 wt.-%, of the flame retardant polypropylene composition (C) as defined above. In an especially preferred embodiment the present invention relates to an article consisting of the flame retardant polypropylene composition (C) as defined above.

Preferably, the article is an automotive article in the field of electronic components such as an electric cable insulation, housings of electric devices, containers and parts of power electronic components of automobile parts and home electric appliance parts, and the like.

The present invention will now be described in further detail by the examples provided below.

### EXAMPLES

### A. Measuring Methods

The following definitions of terms and determination methods apply for the above general description of the invention as well as to the below examples unless otherwise defined. MFR₂ (230° C.) is measured according to ISO 1133 (230° C., 2.16 kg load).

### Quantification of Microstructure by NMR Spectroscopy

Quantitative nuclear-magnetic resonance (NMR) spectroscopy was used to quantify the comonomer content and comonomer sequence distribution of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6 k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

For polypropylene homopolymers all chemical shifts are internally referenced to the methyl isotactic pentad (mmmm) at 21.85 ppm.

Characteristic signals corresponding to regio defects (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) or comonomer were observed.

The tacticity distribution was quantified through integration of the methyl region between 23.6-19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromoleucles 30 (1997) 6251).

Specifically the influence of regio defects and comonomer on the quantification of the tacticity distribution was corrected for by subtraction of representative regio defect and comonomer integrals from the specific integral regions of the stereo sequences.

The isotacticity was determined at the pentad level and reported as the percentage of isotactic pentad (mmmm) sequences with respect to all pentad sequences:

$$[ mmmm ] \% = 100 * ( mmmm / sum of all pentads )$$

The presence of 2,1 erythro regio defects was indicated by the presence of the two methyl sites at 17.7 and 17.2 ppm and confirmed by other characteristic sites.

Characteristic signals corresponding to other types of regio defects were not observed (Resconi, L., Cavallo, L., Fait, A., Piemontesi, F., Chem. Rev. 2000, 100, 1253).

The amount of 2,1 erythro regio defects was quantified using the average integral of the two characteristic methyl sites at 17.7 and 17.2 ppm:

$${P}_{21 e} = ( {I}_{e 6} + {I}_{e 8} ) / 2$$

The amount of 1,2 primary inserted propene was quantified based on the methyl region with correction undertaken for sites included in this region not related to primary insertion and for primary insertion sites excluded from this region:

$${P}_{12} = {I}_{CH 3} + {P}_{12 e}$$

The total amount of propene was quantified as the sum of primary inserted propene and all other present regio defects:

$${P}_{total} = {P}_{12} + {P}_{21 e}$$

The mole percent of 2,1 erythro regio defects was quantified with respect to all propene:

$$[ 21 e ] mol \% = 100 * ( {P}_{21 e} / {P}_{total} )$$

For copolymers characteristic signals corresponding to the incorporation of ethylene were observed (Cheng, H. N., Macromolecules 17 (1984), 1950).

With regio defects also observed (Resconi, L., Cavallo, L., Fait, A., Piemontesi, F., Chem. Rev. 2000, 100, 1253; Wang, W-J., Zhu, S., Macromolecules 33 (2000), 1157; Cheng, H. N., Macromolecules 17 (1984), 1950) correction for the influence of such defects on the comonomer content was required.

The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( S α β + S αγ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

E[mol %]=100*fE

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

The comonomer sequence distribution at the triad level was determined using the analysis method of Kakugo et al. (Kakugo, M., Naito, Y., Mizunuma, K., Miyatake, T.

Macromolecules 15 (1982) 1150). This method was chosen for its robust nature and integration regions slightly adjusted to increase applicability to a wider range of comonomer contents.

Intrinsic viscosity (IV) of propylene homopolymers and copolymers is measured according to DIN ISO 1628/1, October 1999 (in Decalin at 135° C.).

The xylene cold solubles (XCS, wt.-%): Content of xylene cold solubles (XCS) was determined at 25° C. according ISO 16152; first edition; 2005-07-01.

Charpy notched impact strength was determined according to ISO 179-1/1eA at 23° C. and −30° C. by using injection moulded test specimens (80×10×4 mm) prepared according to EN ISO 1873-2.

Tensile properties were determined on injection moulded dogbone specimens of 4 mm thickness prepared in accordance with EN ISO 1873-2. Tensile modulus was determined according to ISO 527-1A at a strain rate of 1 mm/min and 23° C., 80° C. and 120° C., stress at yield was determined at a strain rate of 50 mm/min and 23° C., 80° C. and 120° C.

UL94 Vertical burning test was performed according to UL 94: 2016. The samples are injection moulded in pieces 125±5 mm length, 13.0±0.5 mm width and a thickness of 0.025-13 mm. Under condition part 1, the samples must be conditioned in a constant room temperature of 23±2° C. and 50±10% humidity for 48 hours. Under condition part 2, the samples must be conditioned in an air-circulating oven for 168 hours at 70±1° C. and then cooled in the desiccator for at least 4 hours at room temperature, prior to testing. Testing must take place within 30 minutes of the samples being taken from the conditioning. The sample is hanged vertically in the test chamber and subjected to a first ignition for 10 sec, then a second ignition for another 10 sec. The burning time after each ignition is recorded and it is also noted if there is afterglow, burning dripping that ignites the cotton in the bottom of the chamber and if there is flames or glow up to holding clamp. Classifications are V-0, V-1, V-2 or no classification (fail), and the classification is dependent on the thickness of the test object.

Limited oxygen index (LOI) (Stanton Redcroft from Rheometric Scientific) was performed by following ASTM D 2863-87 and ISO 4589. The plaques prepared as described above were placed in a climate room with relative humidity 50±5% and temperature 23° C. for at least 24 hours prior to the test. Ten sample rods having length 135 mm, width 6.5 mm and thickness of 3 mm were punched from a plaque. A single sample rod was placed vertically in a glass chimney with a controlled atmosphere of oxygen and nitrogen that had been flowing through the chimney for at least 30 seconds and then ignited by an external flame on the top. If the sample had a flame present after three minutes or if the flame had burned down more than 50 mm, the test failed. Different oxygen concentrations were tested until a minimum oxygen level was reached were the sample passed the test and the flame was extinguished before three minutes or 50 mm.

Oxygen initiation time (OIT) was performed according to ISO 11357-6, ASTM D3895, IEC 60811-4-2/B. The specimen (2-10 mg) prepared according to the standards and the empty reference crucible are heated in a DSC device at a constant rate in an inert gaseous environment (nitrogen). When the specified temperature has been reached and the sample has been held in isothermal conditions for 5 minutes, the atmosphere is changed to oxygen maintained at the same flow rate. The specimen is then held at constant temperature (in the present case 190° C.), until the oxidative reaction is displayed on the thermal curve. The induction period is the time interval between the initiation of oxygen flow and the onset of the oxidative reaction. The end of the induction period is signaled by an abrupt increase in the evolved heat or temperature.

### Dripping Test

This method is intended to determine how different formulations drops, when they burn. A metal grid with a size of 8 meshes and diameter of 150 mm is used. Each polymer composition test plate is pressed into 3.0 mm thickness and cut to an area of 65×65 mm. Before testing, the sample is conditioned at 23° C. for at least 16 hours at 50% relative humidity. The test is then carried out in a fume cupboard. The temperature in the fume cupboard shall be (23±10° C.) Calibration of a flow-meter is performed when changing the gas bottle. The recorder is calibrated and the flow on the flow-meter is set to Butane: 650±−30 ml/min (23° C., 100 kPa). The plate is placed in the middle of a net. A burner is lighted with a stable flame of approximately 130 mm with an inner blue flame of approximately 50 mm. The burner is placed at a 45 degree angle inclined towards the centre of the sample and that the tip of the inner blue flame hits the centre of the surface of the test object. The burner is kept in this position during the entire text execution. The test time varies greatly depending on the flammability of the material. When the sample is stops burning the burner is removed. At least three tests per sample are performed. The drops are collected in a water bath at the bottom. The water is dried away and the drops are weighted. The weight of the dried droplet remains is divided by the original mass (m/m) and calculated as weight % of the original mass. The test is a comparable test and can divide to comparable materials.

### Cone Calorimeter

Time to ignition was tested in a Fire Testing Technology (FTT) cone calorimeter according to ISO5660-1:2019. Test objects were compression moulded plaques of 100×100×3 mm³, prepared according to ISO 293 on a Collin press. The pellets were pressed in between two Mylar film sheets and positioned in a specific frame with the correct shape and dimensions. The samples were pressed by applying 20 bar for a minute at 170° C., followed by 200 bars pressure for 5 minutes at the same temperature. The remaining compression was done at the same high pressure for 9 minutes at a cooling rate of 15° C./min. The amount of pellets used for each plaque was calculated using the density of the material with an excess of 10 wt %. The plaques were placed in a climate room with relative humidity 50±5% and temperature 23° C. for at least 24 hours prior to the test. Before initializing the tests, the smoke system, gas analyzers, c-factor value, heat flux and scale were calibrated through software ConeCalc 5. Drying aid and Balston filter were checked and exchanged if necessary. The sample plaques were weighed and the exact dimensions were determined before the bottom and sides were wrapped in a 0.3 mm thick aluminium foil and placed in a sample holder filled with a fiber blanket and a frame on top. The sample was placed in a horizontal position on a loading cell 60 mm from the cone radiant heater with heat flux 35 kW/m² and volume flow rate 24 l/mm.

### 2. Examples

### The Propylene Polymer (PP)

### Catalyst Preparation

The catalyst for the preparation of PP was prepared as follows:

3,4 litre of 2-ethylhexanol and 810 mL of propylene glycol butyl monoether (in a molar ratio 4/1) were added to a 20 L reactor. Then 7.8 litre of a 20% solution in toluene of BEM (butyl ethyl magnesium) provided by Crompton GmbH were slowly added to the well stirred alcohol mixture. During the addition the temperature was kept at 10° C. After addition the temperature of the reaction mixture was raised to 60° C. and mixing was continued at this temperature for 30 minutes. Finally after cooling to room temperature the obtained Mg-alkoxide was transferred to storage vessel. 21.2 g of Mg alkoxide prepared above was mixed with 4.0 mL bis(2-ethylhexyl) citraconate for 5 min. After mixing the obtained Mg complex was used immediately in the preparation of catalyst component. 19.5 mL titanium tetrachloride was placed in a 300 mL reactor equipped with a mechanical stirrer at 25° C. Mixing speed was adjusted to 170 rpm. 26.0 of Mg-complex prepared above was added within 30 minutes keeping the temperature at 25° C. 0.3.0 mL of Viscoplex 1-254 and 1.0 mL of a toluene solution with 2 mg Necadd 447 was added. Then 24.0 mL of heptane was added to form an emulsion. Mixing was continued for 30 minutes at 25° C. Then the reactor temperature was raised to 90° C. within 30 minutes. The reaction mixture was stirred for further 30 minutes at 90° C. Afterwards stirring was stopped and the reaction mixture was allowed to settle for 15 minutes at 90° C.

The solid material was washed 5 times: Washings were made at 80° C. under stirring 30 min with 170 rpm. After stirring was stopped the reaction mixture was allowed to settle for 20-30 minutes and followed by siphoning.
Wash 1: Washing was made with a mixture of 100 ml of toluene and 1 mL donor
Wash 2: Washing was made with a mixture of 30 ml of TiCl₄ and 1 mL of donor.
Wash 3: Washing was made with 100 mL toluene.
Wash 4: Washing was made with 60 mL of heptane.
Wash 5. Washing was made with 60 mL of heptane under 10 minutes stirring.

Afterwards stirring was stopped and the reaction mixture was allowed to settle for 10 minutes decreasing the temperature to 70° C. with subsequent siphoning, and followed by N₂ sparging for 20 minutes to yield an air sensitive powder.

### VCH Modification of the Catalyst

35 mL of mineral oil (Paraffinum Liquidum PL68) was added to a 125 mL stainless steel reactor followed by 0.82 g of triethyl aluminium (TEAL) and 0.33 g of dicyclopentyl dimethoxy silane (donor D) under inert conditions at room temperature. After 10 minutes 5.0 g of the catalyst prepared in 1a (Ti content 1.4 wt %) was added and after additionally 20 minutes 5.0 g of vinylcyclohexane (VCH) was added). The temperature was increased to 60° C. during 30 minutes and was kept there for 20 hours. Finally, the temperature was decreased to 20° C. and the concentration of unreacted VCH in the oil/catalyst mixture was analyzed and was found to be 120 ppm weight.

The process for the preparation of the propylene polymer (PP) being a heterophasic propylene copolymer is summarized in Table 1.

TABLE 1
Preparation of the propylene polymer (PP)

| | | PP |
|---|---|---|
| Prepolymerization | | |
| Co/Donor | [mol/mol] | 20 |
| Co/Ti | [mol/mol] | 250 |
| Temperature | [° C.] | 21 |
| Residence time | [min] | 20 |
| Loop (R1) | | |
| Temperature | [° C.] | 80 |
| Split | [wt.-%] | 51 |
| H2/C3 | [mol/kmol] | 6.40 |
| MFR | [g/10 min] | 42 |
| GPR1 (R2) | | |
| Temperature | [° C.] | 80 |
| Split | [wt.-%] | 30 |
| H2/C3 | [mol/kmol] | 69.3 |
| MFR | [g/10 min] | 42 |
| XCS | [wt.-%] | 2.0 |
| GPR2 (R3) | | |
| Temperature | [° C.] | 80 |
| C2/C3 | [mol/kmol] | 399 |
| H2/C2 | [mol/kmol] | 84 |
| Split | [wt.-%] | 19 |
| MFR | [g/10 min] | 19.0 |
| Final | | |
| XCS | [wt.-%] | 17.5 |
| C2(total) | [mol-%] | 7.5 |
| C2(XCS) | [mol-%] | 43.6 |
| IV(XCS) | [dL/g] | 2.6 |
| MFR | [g/10 min] | 20 |
| Tm | [° C.] | 166 |
| Tc | [° C.] | 130 |
| density | [kg/m³] | 905 |

### Preparation of the Polypropylene Composition (C)

The propylene polymer PP was melt blended on a co-rotating twin screw extruder with the flame retardant composition (FR) and the antidripping-agent (A) in amounts as indicated in Table 2 below.

TABLE 2
Composition and properties of the comparative and inventive examples

| | | CE1 | CE2 | CE3 | CE4 | CE5 | IE1 |
|---|---|---|---|---|---|---|---|
| PP | [wt.-%] | 79 | 75 | 77 | 79 | 74.8 | 79 |
| FR | [wt.-%] | 21 | 20 | 20 | 18 | 25 | 20 |
| Lignin | [wt.-%] | | 5 | 3 | 3 | | 1 |
| PTFE | [wt.-%] | | | | | 0.2 | |
| MFR | [g/10 min] | 16.0 | 17.3 | 18.6 | 19.4 | 14.0 | 17.2 |
| NIS | [kJ/m²] | 35 | 27 | 38 | 38 | 80 | 66 |
| Dripping test | [%] | 6.1 | 0 | 0.3 | 0.2 | 6.4 | 0.8 |
| UL 94 (1.6 mm) | [—] | Fail¹ | Fail¹ | Fail¹ | Fail¹ | V-0¹ | V-0¹ |
| Cone time | [s] | 37 | 18 | 20 | 19 | 35 | 25 |
| to ignition | | | | | | | |
| OIT 190° C. | [min] | 5.1 | 91.5 | 81.7 | 82.6 | nd | 72.6 |
| LOI | [%] | 32.5 | 26.0 | 29.5 | 26.0 | 35.8 | 32.5 |
| TM | [MPa] | 1843 | 1778 | 1770 | 1700 | 2077 | 1776 |
| Tensile strain | [%] | 19 | 44 | 44 | 49 | 35 | 63 |
| at break | | | | | | | |

¹After pretreatment condition I of the UL 94 test

FR is the commercial flame retardant composition Phlamoon-1090A of SULI comprising 55 to 60 wt.-% melamine polyphosphate and 40 to 55 wt.-% piperazine pyrophosphate.
Lignin is the commercial lignin Ligflow 401 (Suzano S. A., Brazil)
PTFE is the commercial PTFE DYNEON TF 2025 Z PTFE (3M)

As can be gathered from Table 2, compositions comprising lignin show an excellent dripping behavior compared to PTFE while the impact and tensile properties remain on a high level.

Furthermore, the limited oxygen index (LOI), a measure of the minimum oxygen concentration required to support combustion (i.e. higher LOI means greater flame retardance) is maintained on a high level (IE1 similar to CE 1, whereas CE2 to CE4 are lower). The oxygen initiation temperature (OIT) is considerably increased via the addition of lignin (CE2-CE4 and IE1 vs. CE1); however, the improvements in OIT must be balanced against other properties, such as the LOI and the cone time to ignition, which can decrease significantly when the lignin/FR ratio is too high (as in CE2 to CE4).

1. A flame retardant polypropylene composition (C), comprising:
i) a propylene polymer (PP),
ii) a nitrogen-containing flame retardant (FR), and
iii) an antidripping-agent (A) being a biopolymer comprising phenolic hydroxyl groups,
wherein the flame retardant polypropylene composition (C) fulfills in-equation (I);
$$( w ( A ) ) / ( w ( FR ) ) < 0.15 \qquad ( I )$$
wherein w(A) is the overall amount of the antidripping-agent (A) in [wt-%], based on the overall weight of the polypropylene composition (C), and w(FR) is the overall amount of the nitrogen-containing flame retardant (FR) in [wt.-%], based on the overall amount of the flame retardant polypropylene composition (C).

2. The flame retardant polypropylene composition (C) according to claim 1, wherein:
i) the flame retardant polypropylene composition (C) is free of fluoropolymers, and
ii) the nitrogen-containing flame retardant (FR) and the antidripping-agent (A) being a biopolymer comprising phenolic hydroxyl groups are free of halogens.

3. The flame retardant polypropylene composition (C) according to claim 1, wherein the antidripping-agent (A) is lignin.

4. The flame retardant polypropylene composition (C) according to claim 1, wherein the nitrogen-containing flame retardant (FR) comprises a first nitrogen-containing phosphate (FR1) and a second nitrogen-containing phosphate (FR2).

5. The flame retardant polypropylene composition (C) according to claim 4, wherein the weight ratio between the first nitrogen-containing phosphate (FR1) and the second nitrogen-containing phosphate (FR2) is in the range of 60:40 to 40:60.

6. The flame retardant polypropylene composition (C) according to claim 4, wherein the first nitrogen-containing phosphate (FR1) is melamine polyphosphate and the second nitrogen-containing phosphate (FR2) is piperazine pyrophosphate.

7. The flame retardant polypropylene composition (C) according to claim 1, comprising:
i) 57.1 to 89.9 wt.-% of the propylene polymer (PP),
ii) 10.0 to 40.0 wt.-% of the nitrogen-containing flame retardant (FR), and
iii) 0.1 to 2.9 wt.-% of the antidripping-agent (A) being a biopolymer comprising phenolic hydroxyl groups,
based on the overall weight of the polypropylene composition (C).

8. The flame retardant polypropylene composition (C) according to claim 7, wherein the overall amounts of the propylene polymer (PP), the nitrogen-containing flame retardant (FR) and the antidripping-agent (A) together make up at least 90 wt.-% of the flame retardant polypropylene composition (C).

9. The flame retardant polypropylene composition (C) according to claim 1, wherein the propylene polymer (PP) is a copolymer of propylene and ethylene and/or a C₄ to C₈ α-olefin having a comonomer content in the range of 2.0 to 25.0 mol %.

10. The flame retardant polypropylene composition (C) according to claim 1, wherein the propylene polymer (PP) is a heterophasic propylene copolymer (HECO) comprising:
i) a matrix (M) being a polymer of propylene, and
ii) an elastomer (E) being a copolymer comprising units derived from propylene and ethylene and/or C₄ to C₈ a-olefin.

11. The flame retardant polypropylene composition (C) according to claim 10, wherein the heterophasic propylene copolymer (HECO) has a xylene cold soluble fraction (XCS) in the range of 7.0 to 25.0 wt.-% based on the overall weigh of the heterophasic propylene copolymer (HECO).

12. The flame retardant polypropylene composition (C) according to claim 11, wherein the xylene soluble fraction (XCS) of the heterophasic propylene copolymer (HECO) has;
i) a comonomer content in the range of 25.0 to 65.0 mol-%, preferably in the range of 40.0 to 45.0 mol-%, and/or
ii) an intrinsic viscosity (IV) measured according to ISO 1628/1 (at 135° C. in decalin) below 3.5 dl/g.

13. The flame retardant polypropylene composition (C) according to claim 1, having a melt flow rate MFR₂ (230° C., 2.16 kg) determined according to ISO 1133 in the range of 6.0 to 40.0 g/10 min.

14. (canceled)

15. An article, comprising the flame retardant polypropylene composition (C) according to claim 1.
